(19) United States
(12) Patent Application Publication
(10) Pub. No.: US 2021/0090461 A1
(43) Pub. Date: Mar. 25, 2021

(54) METHODS FOR MANAGING REPAIR OF VEHICLE DAMAGE WITH HEAD MOUNTED DISPLAY DEVICE AND DEVICES THEREOF

(71) Applicant: Mitchell International, Inc., San Diego, CA (US)

(72) Inventors: Umberto Laurent Cannarsa, Carlsbad, CA (US); John Anthony Bachman, San Diego, CA (US); Daniel Jake Kovar, Santee, CA (US)

(21) Appl. No.: 16/823,107

(22) Filed: Mar. 18, 2020

Related U.S. Application Data
(60) Provisional application No. 62/904,402, filed on Sep. 23, 2019.

(51) Int. Cl. G09B 19/00; G06K 9/32; G06K 9/00; G09B 5/02

(52) U.S. Cl. CPC G09B 19/003; G06K 9/3258; G09B 5/065; G09B 5/02; G06K 2209/15; G06K 9/00671

(57) ABSTRACT

Systems and methods are provided for generating repair procedures, which are displayed on a client computing device as a series of repair steps based on a determined order. A user may be directed to capture an image that includes vehicle identifying information or license plate number using a computer wearable device. The damage information, repair estimate information, and repair procedure information may be obtained based on the damaged vehicle information. Individual repair procedures and their order are determined by analyzing the damage information, repair estimate information, repair procedure information, diagnostic codes, and historical repair data. The user may use the system in a handsfree manner by viewing the repair procedures in a display of a computer wearable device which allows the user to view the repair information while performing the repairs. Additionally, the user may use voice commands or gesture to control the display of particular repair procedures.

### RELATED APPLICATIONS

This application claims the benefit of U.S. Provisional Application No. 62/904,402 filed on Sep. 23, 2019, the contents of which are incorporated herein by reference in its entirety.

### TECHNICAL FIELD

The present disclosure is generally related to automobiles. More particularly, the present disclosure is directed to automotive repair technology.

### BACKGROUND

All vehicle models are built differently, with different processes, different components, and different materials. As a result, repairing a damaged vehicle requires following a set of specific repair procedures based on the type of vehicle and the type of damage.

Repair technicians rely on repair procedures for identifying various operations and actions they need to take to repair the damaged vehicle and the tools they need to use. Unfortunately, because of the large number of vehicle models and the vast amount of available repair procedures, the current selection of relevant repair procedures is subject to a higher than desired rate of errors.

Existing technological tools used to identify and obtain the necessary repair procedures are limited to software searching tools. However, repair procedures are often located in multiple places making conventional tools ineffective. As a result, the current process for identifying and obtaining the necessary repair procedures is time consuming and prone to errors, often resulting in missing and/or misidentified the necessary repair procedures.

Additionally, conventional tools frequently fail to provide the necessary repair procedures in a manner that facilitates execution of the actual repairs or in a manner that facilitates necessary confirmation or assessment of completion for insurance and safety.

Accordingly, conventional processes are susceptible to human error, are time consuming, and require a number of hands-on operations by the repair technician.

### SUMMARY

In accordance with one or more embodiments, various features and functionality can be provided to enable or otherwise facilitate generation of repair procedures which are displayed on a client computing device as a series of repair procedure steps based on a determined sequence.

In some embodiments, a method for facilitating hands-free repair of a damage vehicle may obtain repair estimate information associated with a damaged vehicle, which may be damaged during an adverse incident. The repair estimate information may be obtained based on vehicle identification information captured by a computing device operated by a user.

In some embodiments, the repair estimate information may include damage information and repair estimate procedures. The damage information may specify one or more damaged parts of the damaged vehicle. The repair estimate procedures may be used for repairing the one or more damaged parts of the damaged vehicle.

In some embodiments, the method may obtain a vehicle repair workflow information based on the damage information associated with the repair estimate information. The vehicle repair workflow information may include repair workflow procedures for repairing the one or more damaged parts of the damaged vehicle.

In some embodiments, the method may obtain vehicle status information comprising at least one of diagnostic information, sensor information, sensor calibration information, frame measurement information, and damage severity information for the damaged vehicle based on the vehicle identification information.

In some embodiments, the method may determine one or more sets of repair procedures, each set comprising individual repair steps, by correlating the repair estimate procedures with the repair workflow procedures.

In some embodiments, the method may determine an order for performing the individual repair steps associated with each set of repair procedures.

In some embodiments, the method may determine the order for performing the individual repair steps associated with each set of repair procedures is based on the vehicle status information collected after the adverse incident. In some embodiments, the method may obtain historic repair information specifying repair procedures previously used to repair vehicle damage corresponding to the one or more damaged parts of the damaged vehicle and use a machine learning algorithm trained on the historic repair information when determining the order for performing the individual repair steps associated with each set of repair procedures.

Finally, the method may effectuate presentation of the one or more sets of repair procedures based on the order of the individual repair steps on the computing device. The presentation of repair procedures may be effectuated on a computer wearable device worn by the user configured to facilitate hands-free repair of the damaged vehicle. In some embodiments, the method may obtain at least one of textual information, image information, and video information associated with individual repair steps of the one or more sets of repair procedures. In some embodiments, the presentation of repair procedures may be effectuated by displaying the textual information, the image information, and the video information on a display of the computing device.

In some embodiments, the method may generate instructions for capturing the vehicle identification information associated with the damaged vehicle using an image capture device of the computing device operated by the user. In some embodiments, the method may effectuate presentation of the instructions on the computing device directing the user to capture an image of the vehicle identification information.

In some embodiments, the method may extract Vehicle Identification Number (VIN) from the captured image of the vehicle identification information. In some embodiments, the method may identify the damaged vehicle based on the extracted VIN, wherein the identifying the damaged vehicle comprise identifying a make, a model and a year of manufacture of the damaged vehicle.

In some embodiments, the method may determine that the one or more sets of repair procedures is completed by obtaining an image of one or more panels associated with the vehicle damage.

In some embodiments, the method may determine a success of completion of each repair step associated with the one or more sets of repair procedures by analyzing the vehicle status information obtained in accordance with the determined order of each individual repair step. The vehicle status information may be collected after the repair step is completed. In some embodiments, the method may receive user input indicating completion of individual repair steps associated with the one or more sets of repair procedures.

### BRIEF DESCRIPTION OF THE DRAWINGS

FIG. 1 illustrates example systems and a network environment, according to an implementation of the disclosure.

FIG. 2 illustrates an example repair management server of the example system of FIG. 1, according to an implementation of the disclosure.

FIGS. 3A-3B illustrate an example client computing device of the example system of FIG. 1, according to an implementation of the disclosure.

FIG. 4 illustrates an example graphical user interface displaying directional instructions during an image capture process, according to an implementation of the disclosure.

FIGS. 5A-5C illustrate an example graphical user interface displaying repair procedures by the client computing device of FIG. 1, according to an implementation of the disclosure.

FIG. 6 illustrates an example process for generating repair procedures, according to an implementation of the disclosure.

FIG. 7 illustrates an example computing system that may be used in implementing various features of embodiments of the disclosed technology.

### DETAILED DESCRIPTION

Described herein are systems and methods for generating repair procedures which are displayed on a client computing device as a series of repair steps based on a determined order. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

As alluded to above, a large variety of vehicles are currently available. The automakers (OEM) have been increasingly incorporating new innovative technology into their vehicles in an effort to make them safer and more convenient. More and more cameras and sensors have been added to vehicles and significant updates to computerized systems have been made. With the proliferation of these new systems, the complexity of repairs has increased exponentially. This is exacerbated by the fact that each vehicle has unique components, including sensors and firmware, and each OEM has their own procedures for handling the repairs. These repair procedures are guides to proper methods of repairing the vehicles, and may be published by OEMs, insurance companies, and other aftermarket data supplier.

As alluded to above, a conventional repair technician must refer to one or more of these repair guides when repairing a damaged vehicle. Repair procedure documentation explains the various steps and actions that need to be taken to repair the vehicle and which tools and materials need to be used. However, because of the diversity in manufacturing standards and the number of potential repair areas, the amount of available repair procedures is overwhelming.

Accordingly, repair technicians have to manually determine which specific repair procedures are applicable to a particular vehicle and particular damage, and subsequently obtain all relevant documents, resulting in delays and potential errors. Depending on the severity of the damage, the industry recognizes that this process takes up 2 hours on average and is further complicated by the fact that a given damage may include several areas of the vehicle. Each area may have its own set of repair procedures. Because several areas may be affected by the damage, the repairs have to be performed in a specific sequence to ensure compliance with OEM and insurance standards. Currently, this sequence is also determined by the repair technician based on their knowledge and expertise. Automatically generating repair procedures for a particular vehicle and determining the order of individual repair operations results in a significant reduction in repair time and user errors.

Once the technician locates the repair procedures and determines the sequence of the repair steps, the technician has to obtain a copy, usually by printing (if available in digital form), and placing it in or next to the vehicle that is being repaired. The technician then reads and consults these documents before and during the repair process. However, there is no convenient way to ensure that the printed documents remain with the vehicle, especially when the vehicle is being dismantled. Some technicians choose to tape the printed pages on the outside of the vehicle, while others place them on the dashboard, risking misplacing or mixing up the order of the repair procedure documents. Furthermore, reading from a printed document while simultaneous performing repairs is not convenient and further increases the length of the repairs. For example, a technician may wear gloves which need to be removed when looking for the next repair document.

Finally, currently available repair technology lacks analytics with respect to performing repairs according to the provided repair procedures in a determined sequence. Requiring that the technician provides confirmation of a completed repair step and verifying that the step was performed in accordance with OEM standards results in decreased liability and savings.

In accordance with various embodiments, a repair technician can obtain repair procedures for viewing as a series of repair steps on a display of a computer wearable device. For example, a technician can input vehicle information used to identify the type of vehicle without entering the information, but rather by using input devices (e.g., a camera) on the computer wearable device, resulting in handsfree data entry. Vehicle information is used to obtain damage information (e.g., from a repair estimate) which, along with the vehicle information, is then used to determine relevant repair procedures, including individual repair steps. Next, estimate data, one or more diagnostic trouble codes (DTC) codes, sensor data from the damaged vehicle, frame measurement data, vehicle specific repair workflow data, damage severity data, and/or other historical data related to this type of damaged vehicle and any other type of data related to this type of damage and this type of vehicle may be used to determine the order in which the retrieved repair procedure steps must be performed.

Because the repair technician can view repair procedures in a determined sequence via a display of a handsfree computer wearable device, the technician is able to perform the repairs at the same time. Additionally, using voice commands or gesture control to navigate within the repair application and to move from one repair procedure to the next further enhances the handsfree operation. Finally, the technician may obtain verification that each repair step was successfully performed, resulting in greater compliance with OEM standards.

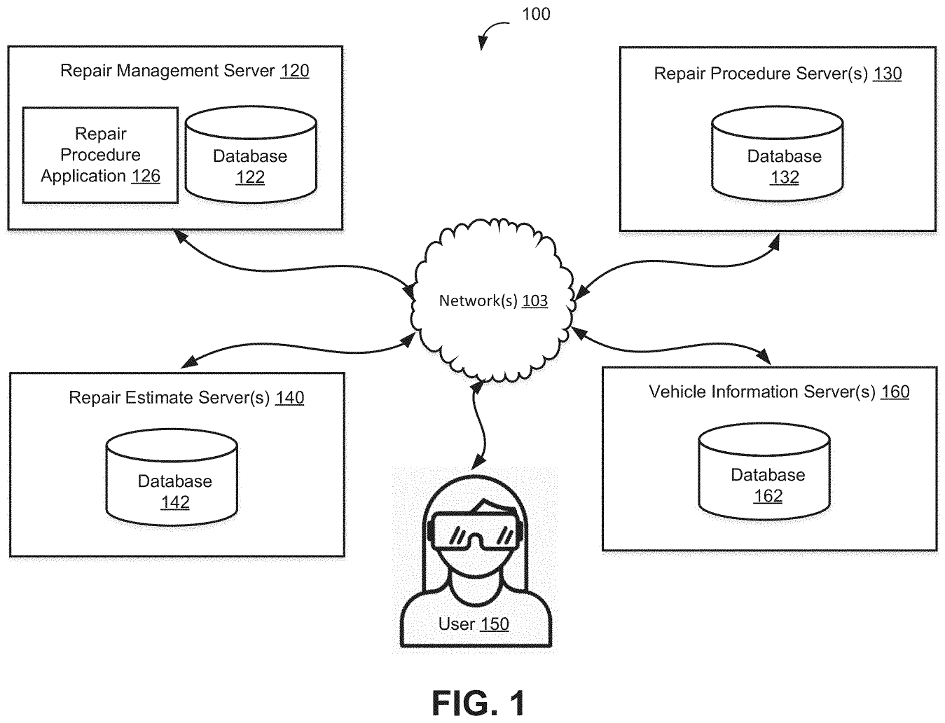

Before describing the technology in detail, it is useful to describe an example environment in which the presently disclosed technology can be implemented. FIG. 1 illustrates one such example environment 100.

FIG. 1 illustrates an example environment 100 which permits users to obtain repair procedures, displayed in a client computing device 104, as a series of repair procedure steps based on a determined sequence. Additionally, users may control the display of repair procedures using voice commands or gesture without having to enter input via a graphical user interface (GUI) resulting in a handsfree operation, as described herein. For example, a repair technician may view a series of repair procedure operations or steps displayed in a particular order or sequence when repairing a damaged item (e.g., a vehicle). In some embodiments, the user may be guided through the repair procedure steps based one or more of a status of repair procedures (e.g., completed repairs), user input (e.g., user choosing to skip over particular repair procedures), and other parameters, as further described herein.

In some embodiments, environment 100 may include a client computing device 104, a repair management server 120, a one or more repair procedure server(s) 130, one or more repair estimate server(s) 140, a one or more vehicle information server(s) 160, and a network 103. A user 150 may be associated with client computing device 104 as described in detail below. Additionally, environment 100 may include other network devices such as one or more routers and/or switches.

In some embodiments, client computing device 104 may include a variety of electronic computing devices, for example, a computer wearable device, such as smart glasses, or any other head mounted display device that can be used by a user (e.g., a vehicle repair technician). In some embodiments, the computer wearable device may include a transparent heads-up display (HUD) or an optical head-mounted display (OHMD). In other embodiments, client computing device 104 may include other types of electronic computing devices, such as, for example, a smartphone, tablet, laptop, virtual reality device, augmented reality device, display, mobile phone, or a combination of any two or more of these data processing devices, and/or other devices.

In some embodiments, client computing device 104 may include one or more components coupled together by a bus or other communication link, although other numbers and/or types of network devices could be used. For example, client computing device 104 may include a processor, a memory, a display (e.g., OHMD), an input device (e.g., a voice/gesture activated control input device), an output device (e.g., a speaker), an image capture device configured to capture still images and videos, and a communication interface.

In some embodiments, client computing device 104 may present content (e.g., repair procedures) to a user and receive user input (e.g., voice commands). For example, client computing device 104 may include a display device, as alluded to above, incorporated in a lens or lenses, and an input device(s), such as interactive buttons and/or a voice or gesture activated control system to detect and process voice/gesture commands. The display of wearable computing device 104 may be configured to display the repair procedures aimed at facilitating a handsfree and voice- and/or gesture-assisted repair of damage to an item, including post subsequent repair assessment. In some embodiments, client computing device 104 may communicate with repair management server 120 via network 103 and may be connected wirelessly or through a wired connection.

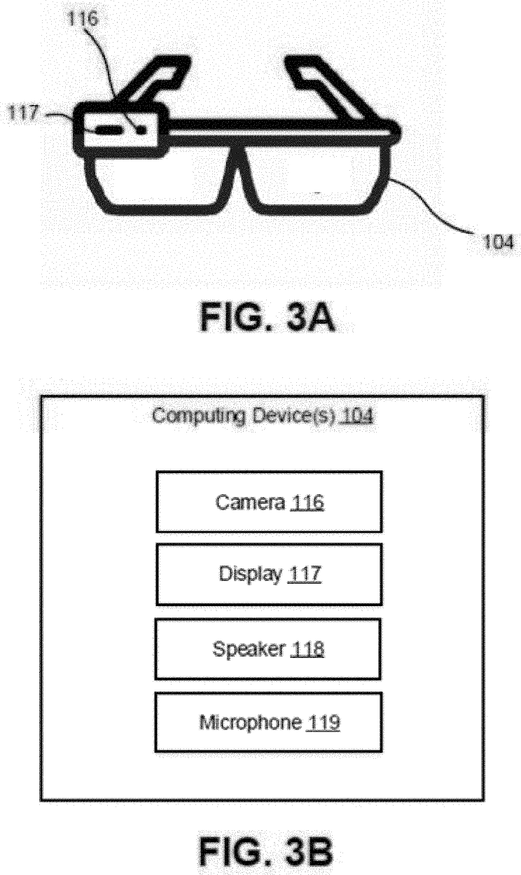

In some embodiments, client computing device 104 such as smart glasses, illustrated in FIGS. 3A-3B, may include a camera 116, a display 117 (e.g., comprising an OHMD), a speaker 118, and a microphone 119, among other standard components.

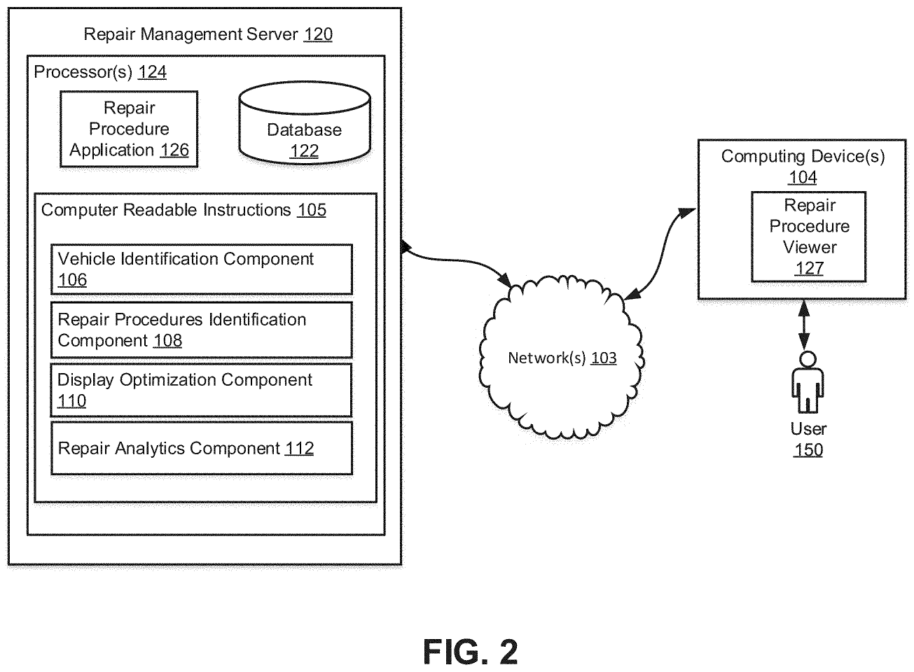

In some embodiments and as will be described in detail in FIG. 2, repair management server 120 may include a processor, a memory, and network communication capabilities. In some embodiments, repair management server 120 may be a hardware server. In some implementations, repair management server 120 may be provided in a virtualized environment, e.g., repair management server 120 may be a virtual machine that is executed on a hardware server that may include one or more other virtual machines. Additionally, in one or more embodiments of this technology, virtual machine(s) running on repair management server 120 may be managed or supervised by a hypervisor. Repair management server 120 may be communicatively coupled to a network 103.

In some embodiments, the memory of repair management server 120 can store application(s) that can include executable instructions that, when executed by repair management server 120, cause repair management server 120 to perform actions or other operations as described and illustrated below with reference to FIG. 2. For example, repair management server 120 may include repair procedure application 126. In some embodiments, repair procedure application 126 may be a distributed application implemented on one or more client computing devices 104 as client repair procedure viewer 127. In some embodiments, distributed repair procedure application 126 may be implemented using a combination of hardware and software. In some embodiments, repair procedure application 126 may be a server application, a server module of a client-server application, or a distributed application (e.g., with a corresponding repair procedure viewer 127 running on one or more client computing devices 104).

For example, user 150 may view the repair procedures displayed in a graphical user interface (GUI) of client repair procedure viewer 127 on a display of wearable device 104 while performing the repairs illustrated in the procedures in a handsfree manner. Additionally, client computing device 104 may accept user input via microphone 119 which allows user 150 to navigate through the repair procedures by using voice commands or gesture control, again leaving the technician's hands free.

As alluded to above, distributed applications (e.g., repair procedure application 126) and client applications (e.g., repair procedure viewer 127) of repair management server 120 may have access to microphone data included in client computing device 104. As alluded to above, users will access and view and listen to repair procedures when repairing damage in a vehicle via client computing device 104 using voice commands or gesture control. In some embodiments, the commands entered by user 150 via microphone 119 of client computing device 104 (illustrated in FIG. 3B) may be recognized by repair procedure application 126. For example, a command entered by user 150 may include user 150 speaking “View Repair Procedures” into microphone 119. In some embodiments, repair procedure application 126 may have access to audio data collected by microphone 119 of client computing device 104. That is, repair procedure application 126 may receive voice commands as input and trigger display events as output based on the voice commands of user 150, as described in further detail below. In yet other embodiments, repair procedure application 126 may receive voice commands as input and trigger voice response events as output based on the voice commands of user 150, as further described in detail below.

The application(s) can be implemented as modules, engines, or components of other application(s). Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the repair management computing device itself, may be located in virtual server(s) running in a cloud-based computing environment rather than being tied to one or more specific physical network computing devices. Also, the application(s) may be running in one or more virtual machines (VMs) executing on the repair management computing device.

In some embodiments, repair management server 120 can be a standalone device or integrated with one or more other devices or apparatuses, such as one or more of the storage devices, for example. For example, repair management server 120 may include or be hosted by one of the storage devices, and other arrangements are also possible.

In some embodiments, repair management server 120 may transmit and receive information to and from one or more of client computing devices 104, one or more repair procedure servers 130, one or more repair estimate servers 140, and/or other servers via network 103. For example, a communication interface of the repair management server 120 may be configured to operatively couple and communicate between client computing device 104 (e.g., a computer wearable device), repair procedure server 130, repair estimate server 140, which are all coupled together by the communication network(s) 103.

In some embodiments, repair procedure server 130 may be configured to store and manage information associated with repair procedures. Repair procedure server 130 may include processor(s), a memory, and a communication interface, which are coupled together by a bus or other communication link, although other numbers and/or types of network devices could be used. In some embodiments, repair procedure server 130 may also include a database 132. For example, database 132 may include a plurality databases configured to store content data associated with repair procedures (e.g., workflow repair procedures, including textual information, images, videos, with and without an audio guide, and/or animations, including 3D animations) demonstrating how to perform repairs of various parts for a variety of different types and models of vehicles. Additionally, database 132 may include sensor calibration documentation data, and other similar information.

Further, one or more databases 132 of repair procedure server 130 may include information related to repair standards (e.g., safety standards or manufacturer standards). The content data associated with repair procedures may be encoded and arranged in accordance with a file type specification comprising a particular set of rules, each type of file (text, image, video, audio, and so on) having an associated set of rules. Common file types are sometimes indicated by the suffix of the file name (e.g., pdf, .txt, .doc, .jpeg, .mpeg, .mpe, .wma), and also or alternatively by the first few bytes of data in the file. Many file types include a header indicating something about the structure of the file, followed by the content data (e.g. text, audio, video, or image data).

In some embodiments, one or more databases of repair procedure server 130 may include additional information associated with repair procedures, including diagnostic trouble codes (DTC) information, sensor data, sensor calibration data, frame measurement information, repair workflow information, damage severity information, and other similar information.

In some embodiments, repair procedure server 130 may be a single device. Alternatively, in some embodiments, repair procedure server 130 may include a plurality of devices. For example, the plurality devices associated with repair procedure server 130 may be distributed across one or more distinct network computing devices that together comprise one or more of repair procedure server 130.

In some embodiments, repair procedure server 130 may not be limited to a particular configuration. Thus, in some embodiments, repair procedure server 130 may contain a plurality of network devices that operate using a master/slave approach, whereby one of the network devices operate to manage and/or otherwise coordinate operations of the other network devices. Additionally, in some embodiments, repair procedure server 130 may comprise different types of vehicle repair procedure data at different locations.

In some embodiments, repair procedure server 130 may operate as a plurality of network devices within a cluster architecture, a peer-to-peer architecture, virtual machines, or within a cloud architecture, for example. Thus, the technology disclosed herein is not to be construed as being limited to a single environment and other configurations and architectures are also envisaged.

In some embodiments, repair estimate server 140 may be configured to store and manage data associated with repair estimates. For example, the data associated with repair estimates may include estimates generated by an insurance carrier or other similar entity. In some embodiments, repair estimate information may include damage information related to a damaged vehicle and one or more repair procedures for repairing the damaged vehicle. In some embodiments, repair estimate server 140 may include any type of computing device that can be used to interface with the repair management server 120 to efficiently optimize handsfree guided repair management of a damaged vehicle. For example, repair estimate server 140 may include a processor, a memory, and a communication interface, which are coupled together by a bus or other communication link, although other numbers and/or types of network devices could be used. In some embodiments, repair estimate server 140 may also include a database 142. For example, database 142 may include a plurality databases configured to store content data associated with estimate information and repair procedures. The repair procedures (e.g., repair and sensor calibration documentation data, images and/or videos for assisting users in their repairs of a variety of different types and models of vehicles) may be the same as the repair procedures stored in database 132 of repair procedure server 130. In other embodiments, the repair procedures stored in database 142 of repair estimate server 140 may be different than repair procedures stored in database 132 repair procedure server 130. In some embodiments, repair estimate server 140 may run interface applications, such as standard web browsers or standalone client applications, which may provide an interface to communicate with the repair management computing device via the communication network(s). In some embodiments, repair estimate server 140 may further include a display device, such as a display screen or touchscreen, and/or an input device, such as a keyboard, for example.

In some embodiments, vehicle information server 160 may be configured to store and manage vehicle information associated with a damaged vehicle. For example, vehicle information may include vehicle identification information, such as VIN number, make, model, and optional modifications (e.g., sub-model and trim level), date and place of manufacture, and similar information related to a damaged vehicle. The vehicle information server 160 may include any type of computing device that can be used to interface with the repair management server 120. For example, vehicle information server 160 may include a processor, a memory, and a communication interface, which are coupled together by a bus or other communication link, although other numbers and/or types of network devices could be used. In some embodiments, vehicle information server 160 may also include a database 162. For example, database 162 may include a plurality databases configured to store content data associated with vehicle information, as indicated above. The vehicle information server 160 may run interface applications, such as standard web browsers or standalone client applications, which may provide an interface to communicate with the repair management computing device via the communication network(s). In some embodiments, vehicle information server 160 may further include a display device, such as a display screen or touchscreen, and/or an input device, such as a keyboard, for example.

Although the exemplary network environment 100 with computing device 104, repair management server 120, repair procedure server 130, repair estimate server 140, and/or vehicle information server 160, and network(s) 103 are described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment, such as client computing device 104, repair management server 120, repair procedure server 130, repair estimate server 140, and/or vehicle information server 160, may be configured to operate as virtual instances on the same physical machine. In other words, one or more of computing device 104, repair management server 120, repair procedure server 130, and/or repair estimate server 140 may operate on the same physical device rather than as separate devices communicating through communication network(s). Additionally, there may be more or fewer devices than computing device 104, repair management server 120, repair procedure server 130, and/or repair estimate server 140.

In addition, two or more computing systems or devices can be substituted for any one of the systems or devices, in any example set forth herein. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including, by way of example, wireless networks, cellular networks, PDNs, the Internet, intranets, and combinations thereof.

In some embodiments, the various below-described components of FIG. 2, including methods, and non-transitory computer readable media may be used to effectively and efficiently optimize handsfree guided repair management of a damaged vehicle.

FIG. 2 illustrates an example repair management server 120 configured in accordance with one embodiment. In some embodiments, as alluded to above, repair management server 120 may include a distributed repair procedure application 126 configured to provide functionality to generate repair procedures and determine the order in which the repair procedures must be performed. The repair procedures may be displayed as a series of repair operations or steps based on a determined sequence on a display associated with client computing device 104, as further described in detail below. In some embodiments, user 150 may view the repair procedures via a GUI associated with repair procedure viewer 127 running on client computing device 104.

In some embodiments, repair management server 120 may also include one or more database(s) 122. For example, database 122 may include a database configured to store data associated with repair procedures generated by repair management server 120 which are accessed and used by user 150 when repairing a damaged vehicle. Additionally, database 122 may store repair completion information, as further described in detail below. Additionally, one or more databases of repair management server 120 may include data related to user's 150 prior interactions or operations, voice commands, gesture commands used to assess damage and view repair information. In yet other embodiments, database 122 may store machine learning data, and/or other information used by repair management server 120.

In some embodiments, distributed repair procedure application 126 may be operable by one or more processor(s) 124 configured to execute one or more computer readable instructions 105 comprising one or more computer program components. In some embodiments, the computer program components may include one or more of a vehicle identification component 106, a repair procedures identification component 108, a display optimization component 110, a repair analytics component 112, and/or other such components.

In some embodiments, vehicle identification component 106 may be configured to obtain identification information associated with a damaged item. For example, vehicle identification component 106 may be configured to provide programmed instructions that guide user 150 (e.g., a repair technician) wearing client computing device 104 to capture vehicle identification information, such as a vehicle identification number (VIN). In some embodiments, user 150 may capture an image associated with a VIN or license plate of the damaged vehicle. In other embodiments, user may provide vehicle identification information, such as audio data captured by a microphone (e.g., microphone 119, illustrated in FIG. 3B) of client computing device 104.

In some embodiments, vehicle identification component 106 may process the captured image data to extract the VIN or license plate number from the captured image data. For example, vehicle identification component 106 may utilize stored optical character recognition programmed instructions to extract the VIN or license plate from the captured image data.

In some embodiments, vehicle identification component 106 may determine additional data using the processed captured image data. For example, vehicle identification component 106 may query database 162 of vehicle information server 160 (illustrated in FIG. 1) to obtain a make, model, and year of manufacture of the vehicle by using extracted the VIN. Alternatively, vehicle identification component 106 may query database 142 of repair estimate server 140 to determine additional data related to the damaged vehicle using the VIN.

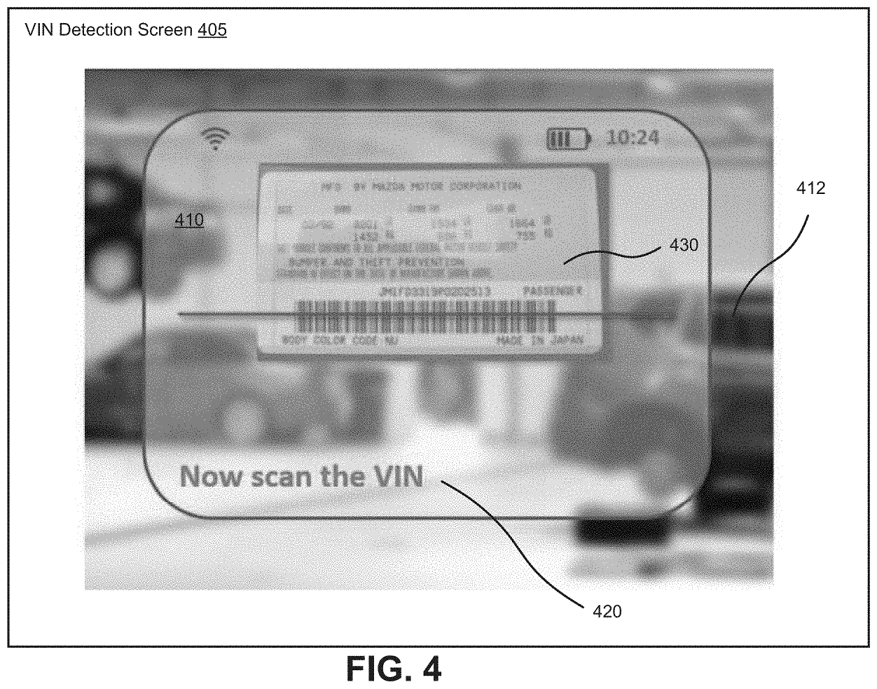

In some embodiments, vehicle identification component 106 may be configured to generate handsfree directional instructions for guiding user 150 during the capture of vehicle identification information. In some embodiments, the directional instructions may be shown on a display of computer wearable device 104. For example, the instructions may include text and/or directional arrows showing where to locate the VIN or when the VIN or license plate is in a view plane for acceptable image capture. For example, as illustrated in FIG. 4, user 150 may be presented with VIN detection screen 405 within a display (e.g., OHMD) of computer wearable device 104 when capturing vehicle identification information of damaged vehicle 412. VIN detection screen 405 may include instructions 420 that guide user 150 to center the camera on a VIN 430 during the image capture process. In some embodiments, instructions 420 may appear under a field of view window 410 within VIN detection screen 405.

Referring back to FIG. 2, the directional instructions may include one or more voice commands transmitted to speaker 118 of client computing device 104 (illustrated in FIG. 3B) informing user 150 what and/or when to capture the image associated of the vehicle identification information.

In some embodiments, vehicle identification component 106 may be configured to generate one or more sets of different types of directional instructions based on the make or model of the vehicle. Different types of directional instructions may include voice commands, visual prompts, such as written text and arrows, or some combination of the above. In some embodiments, vehicle identification component 106 may generate a set of directional instructions of a particular type based on positional information of user 150. For example, user may obtain information associated with user's 150 location with respect to the vehicle. Next, vehicle identification component 106 may determine that user 150 is not proximately positioned to the location or area corresponding to a part of the vehicle that displays the VIN number (e.g., windshield), and generate an audio command instructing the user 150 to move to the correct location. That is, upon determining that the user is not in the location or area corresponding to the part of the vehicle that displays the VIN number, the instructions may assist the user in located the correct area. In some embodiments, when determining user's 150 location with respect to the vehicle, vehicle identification component 106 may use one or more of computer vision, device tracking, augmented reality, or similar technologies to identify user's location.

In some embodiments, vehicle identification component 106 may be configured to generate a handsfree confirmation informing user 150 that the image capture process was accomplished successfully. In some embodiments, the confirmation may include a message shown on the display of computer wearable device 104. In yet other embodiments, confirmation may include one or more voice commands transmitted to speaker 118 of client computing device 104 (illustrated in FIG. 3B) informing user 150 that the image capture process was accomplished successfully.

In some embodiments, repair procedures identification component 108 may be configured to obtain one or more sets of repair procedures comprising one or more steps or operations for repairing the damaged item (e.g., a vehicle damaged in a collision accident). As set forth above, a damaged vehicle may have more than one area that needs to be repaired. For example, in a collision accident, a vehicle may have damage to a front bumper, a windshield, and a front passenger door. Obtaining individual repair operations or steps for each set of repair procedures ensures that user 150 receives all relevant repair procedure necessary to complete the repair process.

In some embodiments, repair procedures identification component 108 may obtain repair procedures based on vehicle identification information determined by vehicle identification component 106 from repair procedure server 130. In other embodiments, repair procedures identification component 108 may obtain repair procedures based on additional vehicle identification information, e.g., make, model, and year of the vehicle determined by vehicle identification component 106. In yet other embodiments, repair procedures identification component 108 may obtain repair procedures based on a particular vehicle panel indicated by visual input, e.g., image data captured by user 150 who is wearing client computing device 104. For example, a front fender of a damaged vehicle may be included in the visual input provided by client computing device 104. Upon processing the captured image data and identifying one or more vehicle panels that user 150 planning on repairing, repair procedures identification component 108 may automatically obtain repair procedures for repairing those vehicle panels.

In some embodiments, repair procedures identification component 108 may obtain repair estimate information comprising damage information and one or more repair procedures for repairing the damaged vehicle. For example, repair procedures identification component 108 may obtain repair estimate information based on vehicle identification information (e.g., VIN or license plate information) determined by vehicle identification component 106 from vehicle information server 160 and/or repair estimate server 140.

In some embodiments, repair procedures identification component 108 may determine a subset of the one or more repair procedures obtained from repair procedure server 130 by correlating repair procedures obtained from repair procedure server 130 with damage information and one or more repair procedures of the estimate information obtained from repair estimate server 140. By virtue of correlating repair procedures obtained from repair procedure server 130 with repair procedures obtained from repair estimate server 140, repair procedures identification component 108 can optimize the subset of the one or more repair procedures. For example, repair procedures identification component 108 may eliminate duplicative or unrelated repair procedures.

In some embodiments, repair procedures identification component 108 may be configured to determine an optimized order in which the individual repair operations associated with each set of repair procedures is to be performed. As alluded to above, because the damage may affect more than one area of a vehicle, and due to an overall increase in vehicle complexity, the sequence of individual operations or steps to be performed by a repair technician is critical to the success of the repair process. For example, by performing the repair procedures (or their individual steps) out of order may result in repair delays and cause loss of revenue. Further still, even if the user performs all relevant repair procedures, but fails to follow the correct sequence may result in liability for the repair shop. Because the order of repair procedures varies based on the vehicle make and model as well as the type and location of the damaged areas, relying on a repair technician's knowledge to determine the sequence is not ideal. Oftentimes, a technician may not be familiar with repairing particular damaged areas in a specific vehicle. Furthermore, even if a repair technician is familiar with the order of the repair steps when repairing a particular area of a damaged vehicle, additional damaged areas may affect the optimized order of the repair steps. Ultimately, determining the optimized order or sequence of repair procedures reduces potential risks identified above.

In some embodiments, the order in which the individual repair operations is performed may be determined based on the obtained repair procedure information and repair estimate information associated with the damaged vehicle, as alluded to above. Further still, repair procedures identification component 108 may use additional information related to the damaged vehicle when determining the order of the repair procedures. For example, repair procedures identification component 108 may access one or more databases that store diagnostic trouble codes (DTC) information, sensor data, sensor calibration documentation, frame measurement information, repair workflow information, damage severity information, and other similar information for each damaged vehicle. In some embodiments, the one or more databases may be configured to operate in a cloud-based and/or virtual computing environment.

In some embodiments, repair procedures identification component 108 may analyze procedure information, repair estimate information, and any additional information in conjunction with one or more predictive models. The predictive models may include one or more of neural networks, Bayesian networks (e.g., Hidden Markov models), expert systems, decision trees, collections of decision trees, support vector machines, or other systems known in the art for addressing problems with large numbers of variables. Specific information analyzed during the determination of the order of individual repair operations may vary depending on the desired functionality of the particular predictive model.

As set forth above, repair procedures identification component 108 may be configured to use machine learning, i.e., a machine learning model that utilizes machine learning to determine a sequence of the repair operations or steps. For example, in a training stage, repair procedures identification component 108 can be trained using training data (e.g., repair procedure information, repair estimate information, diagnostic trouble codes (DTC) information, sensor data from a damaged vehicle, sensor calibration documentation, frame measurement information, repair workflow information, damage severity information, and/or other historical data related to similarly damaged vehicles or similar damages on other vehicles) of actual repair procedures. Then, at an inference stage, component 108 can determine an order of the repair operations or steps of the one or more repair procedures or other data it receives. In some embodiments, the machine learning model can be trained using synthetic data, e.g., data that is automatically generated by a computer, with no use of user information.

In some embodiments, repair procedures identification component 108 may be configured to use one or more of a deep learning model, a logistic regression model, a Long Short Term Memory (LSTM) network, supervised or unsupervised model, etc. In some embodiments, repair procedures identification component 108 may utilize a trained machine learning classification model. For example, the machine learning may include decision trees and forests, hidden Markov models, statistical models, cache language model, and/or other models. In some embodiments, the machine learning may be unsupervised, semi-supervised, and/or incorporate deep learning techniques.

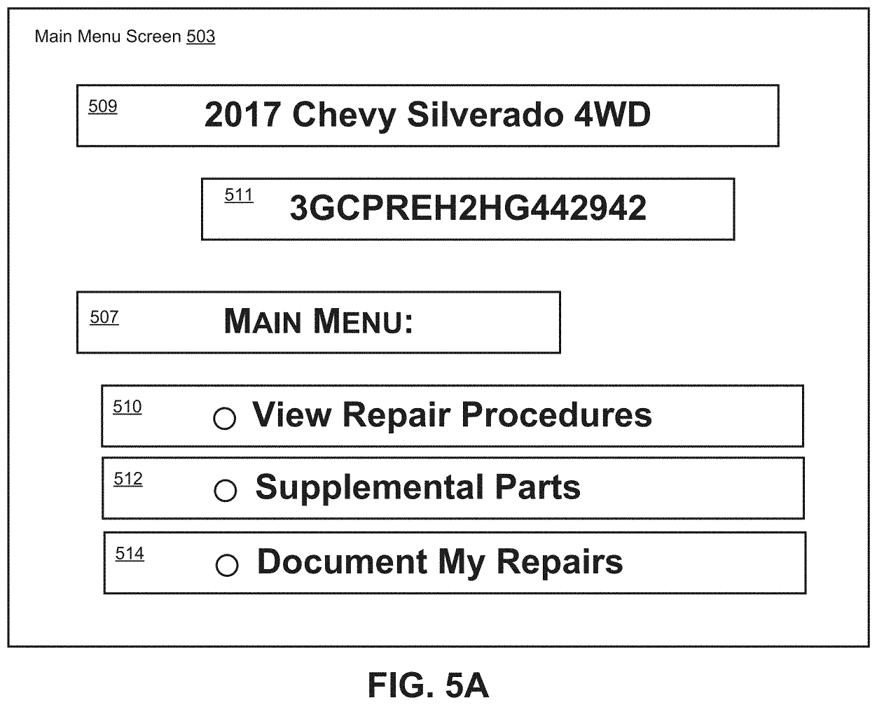

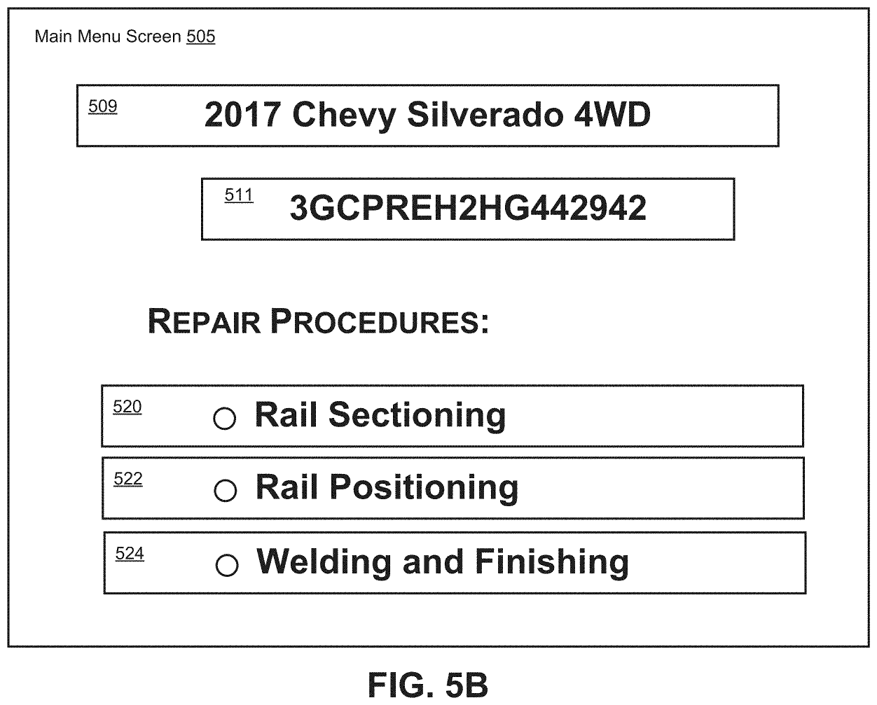

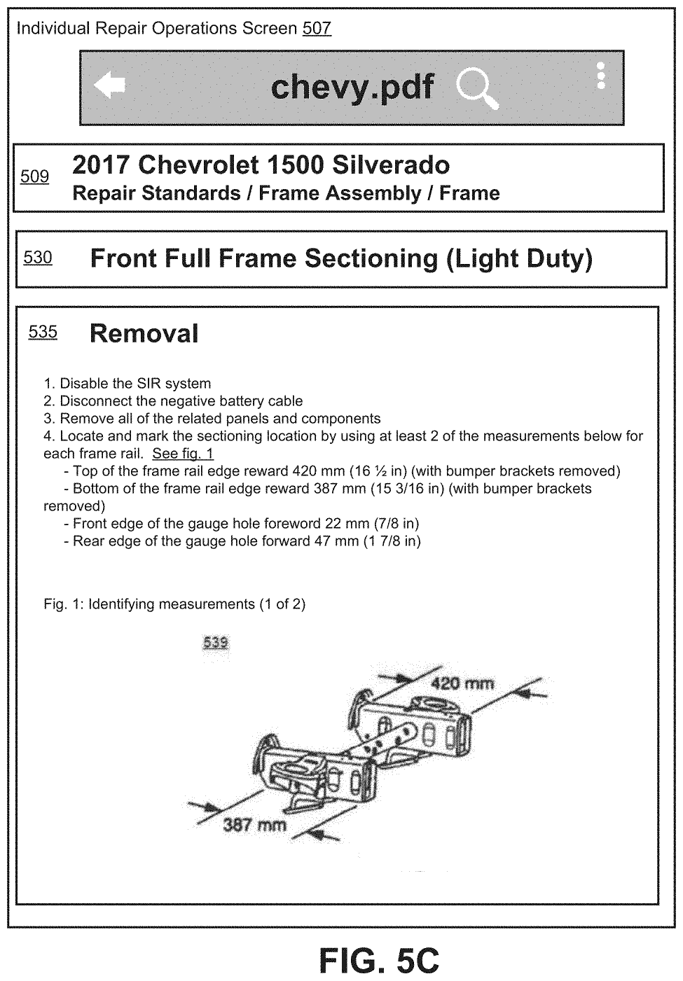

For example, as illustrated in FIG. 5B, three repair procedures, such as a process of rail sectioning 520, a process of rail positioning 522, and a process of welding and finishing 524, may be presented to the user in a repair procedures screen 505 viewable via a GUI. As set forth above, repair procedures identification component 108 may determine that the order in which the user must perform these repair procedures includes completing rail sectioning process 520, followed by rail positioning process 522, and then welding and finishing process 524. By determining the order of the repair procedures, repair procedures identification component 108 ensures that the user performs the repairs according to manufacturer specifications for the damaged vehicle.

In some embodiments, repair procedures identification component 108 may modify the optimized order in which the individual repair operations associated with each set of repair procedures based on user input. For example, user 150 may indicate that the repairs will only be focused on a particular area of the vehicle. In some embodiments, the user may provide input as a voice command or a gesture (e.g., identifying the area) or as a captured image associated with the vehicle area. Upon receiving the user input, procedures identification component 108 may determine an optimized order of repair operations only for the set of repair procedures that is to be performed on the user identified area of the damaged vehicle.

In some embodiments, repair procedures identification component 108 may obtain information related to data from one or more sensors onboard a damaged vehicles. For example, repair procedures identification component 108 may obtain a set of vehicle sensor information which was gathered prior to the damage incident, and a set of vehicle sensor information which was gathered after the damage incident. Additionally, a set of vehicle sensor information may be gathered after the completion of the repairs to determine the success of the repairs, as described in detail further below. Vehicle sensor information may include diagnostic trouble codes (DTC) and communication errors corresponding to various damaged control modules, sensors, cameras, and other components on the vehicle. Vehicle sensor information may be obtained by telemetry, by directly scanning a vehicle's on-board computer, or by any such similar method.

In some embodiments, repair procedures identification component 108 may modify repair procedures based on the vehicle sensor information. Vehicle sensor information may be used to determine one or more sensors affected by the damage incident. By determining the one or more sensors affected by the damage incident, procedures identification component 108 may modify repair procedures by including corresponding calibration documents or other data in a particular repair procedure step to ensure that all necessary or recommended safety checks (e.g., sensor calibrations) are performed during a particular repair procedure step.

In some embodiments, display optimization component 110 may be configured to display the repair procedures based on the order determined by repair procedures identification component 108. Upon determining the order, repair procedures identification component 108 may index individual repair operations and/or assign a sequence number. Individual repair procedures and their order may be stored as a repair plan. The repair plan may be stored as an artifact in one or more database(s) 120 of repair management server 120. In some embodiments, the repair plan may be related to a corresponding estimate of a particular damaged vehicle. The use of sequence numbers associated with individual operations within the set of repair procedures allows display optimization component 110 to display individual repair operations in the order determined by repair procedures identification component 108, as alluded to above.

In some embodiments, display optimization component 110 may be configured to effectuate presentation of information related to repairing a damaged vehicle via a GUI associated with repair procedure viewer 127 running on client computing device 104 operated by user 150. For example, display optimization component 110 may effectuate presentation of one or more screens that user 150 may navigate using voice commands or gesture control, as set forth above. In some embodiments, a first screen may include information related to the damaged vehicle, identified using vehicle information and VIN information determined by vehicle identification component 106. For example, as illustrated in FIG. 5A, vehicle information 509 and VIN information 511 may be presented to the user in a main menu screen 503 of a computer wearable device. In some embodiments, each screen may be identified via a corresponding label. For example, main menu screen 503 may be identified by a Main Menu label 507.

In some embodiments, the first screen may include one or more options for additional information available for selection by user 150. The one or more options may also be identified via a corresponding label. User 150 may select a particular option by using a voice command, a gesture control, or other command associated with the label. For example, main menu screen 503 may include View Repair Procedures 510, Supplemental Parts 512, and Document My Repairs 514 information be identified by a Main Menu label 507. By inputting a voice command “View Repair Procedures,” or using an associated gesture the user may be presented with a repair procedures screen 505 illustrated in FIG. 5B. The use of labels to identify the one or more screens results in a presentation of information that is convenient to both view and navigate. For example, user 150 may return to a previous screen by inputting a voice command “Main Menu.” Alternatively, user 150 may use one or more gestures that allow the user to return to the “Main Menu.”

In some embodiments, display optimization component 110 may be configured to determine one or more display parameters for displaying each repair operation of the repair procedures in a GUI associated with repair procedure viewer 127 running on client computing device 104. For example, display optimization component 110 may adjust the display of one or more repair operations based on the type of the display associated with client computing device 104 (e.g., OHMD).

In some embodiments, display optimization component 110 may obtain device information from client computing device 104 related to its type, size of display, functional specifications, and other such information. Further, display optimization component 110 may use the device information to obtain one or more display rules associated with that device. In some embodiments, display optimization component 110 may determine a set of display instructions for displaying repair procedures in a format for optimized display on client computing device 104 based on the one or more display rules associated with client computing device 104.

In some embodiments, display optimization component 110 may apply the set of display instructions to individual repair operation information within the set of repair procedures. By using the device information to determine the display instructions for displaying the information related to individual repair operations, display optimization component 110 ensures that each operation can be clearly viewed within the display of a particular client computing device. For example, display optimization component 110 may format a document associated with a particular repair procedure operation (e.g., by dividing it into one or more parts) to optimize its display.

For example, as illustrated in FIG. 5C, a repair procedure information 535 associated with a Front Full Frame Sectioning repair procedure step 530 used for repairing vehicle 509, may be presented to the user in an individual repair operation screen 507 of the GUI running on the computer wearable device. Repair procedure information 535 may include textual information 537 and graphical information 539. By determining the display instructions for displaying repair procedure information 535, display optimization component 110 permits both textual information 537 and graphical information 539 to fit within the display of the computer wearable device.

In some embodiments, display optimization component 110 may be configured to effectuate presentation of information related to individual repair steps based on user input. For example, display optimization component 110 may scroll, enlarge, or otherwise adjust the display of the repair information based on one or more corresponding user voice commands, gesture commands, or other input. In some embodiments, display optimization component 110 may adjust the display of information automatically upon determining the display instructions, as alluded to above. Similarly, in some instances the system may display the graphical parts of the document only and read (through text-to-speech) the written instructions through the device's speaker. For example, the system may display graphical information 539 only and “read” textual information 537 without displaying them.

In some embodiments, display optimization component 110 may be configured to effectuate presentation of a subsequent individual repair operation from an order of operations determined by repair procedures identification component 108. For example, subsequent repair operation may be presented after a confirmation indicating that the repairs associated with a previous operation have been completed is received. In some embodiments, the confirmation may be obtained as user input. In yet other embodiments, display optimization component 110 may be configured to use other input (e.g., sensor data information). As alluded to above, conventionally, repair technicians have to print individual repair procedure documents and are required to keep them organized, which is often impossible in a hectic repair shop environment often resulting in lost or misplaced documents. By using a voice command or a gesture to display a particular repair operation (e.g., subsequent or previous), user 150 is able to control the presentation of the repair procedures in a handsfree manner. Additionally, display optimization component 110 may be configured to pause, stop, or restart the presentation of the next repair operation based on user input. As alluded to above, some users may want to control the display of repair information through natural language commands rather than predetermined voice commands. For example, “next step” may be a predetermined voice command, configured to trigger display of a subsequent repair operation. If natural language processing is utilized, user 150 may say “What is the next step?” to view the subsequent repair step.

In some embodiments, repair analytics component 112 may be configured to provide programmed instructions for executing one or more repair reporting operations. For example, repair analytics component 112 may determine a level of completion and a level of success associated with individual repair procedures and/or steps as they are performed by the repair technician and generate a report detailing this information, as described in detail below.

In some embodiments, repair analytics component 112 may obtain information related to the completion of a current repair procedure operation. For example, repair completion information may be obtained from client computing device 104, including one or more captured images or other data related to the repair and/or testing procedures executed during the current repair procedure step.

In some embodiments, repair analytics component 112 may be configured to determine if a repair procedure step which is being viewed by user 150 has been completed based on user generated input. For example, user may transmit a voice command via microphone 119 (illustrated in FIG. 3B) of client computing device 104, or a gesture command indicating that a particular repair operation has been completed. In other embodiments, repair analytics component 112 may be configured to determine if a current repair procedure step has been completed based on other information obtained from the client computing device 104. For example, an individual repair step may include information related to the time it takes to complete that step (e.g., average time). Upon determining that the time required to perform repairs associated with a particular step has elapsed, repair analytics component 112 may ask user 150 to confirm the completion of that step. In yet other embodiments, repair analytics component 112 may determine that a particular procedure step has been completed upon receiving input that user 150 has navigated to a subsequent repair step.

In some embodiments, repair analytics component 112 may determine if a repair procedure step which is being viewed by user 150 has not been completed. For example, upon determining that the repair procedure step has not been completed, repair analytics component 112 may prevent user 150 from viewing a subsequent repair procedure step until a determination confirming that the current repair procedure step has been completed is made.

In some embodiments, repair analytics component 112 may determine that all repair procedure steps associated with a particular repair procedure have been completed. For example, upon determining that all the repair procedure steps have been completed, repair analytics component 112 may allow user 150 to view the next repair procedure, including the repair procedure steps associated with that procedure.

In some embodiments, repair analytics component 112 may be configured to request repair completion information from user 150. For example, repair analytics component 112 may generate a request for additional information related to the current repair procedure step and transmitting it to client computing device 104. In some embodiments, the request may include an audio prompt outputted by speaker 118 (illustrated in FIG. 3B) of client computing device 104.

In some embodiments, repair analytics component 112 may use the repair completion information to determine whether a particular repair procedure step was completed successfully. For example, images of the completed repair obtained from user 150 may be analyzed to determine if the repair procedure was performed in accordance with manufacturer standards. In other embodiments, repair analytics component 112 may use lack of DTC codes for a particular sensor when determining if the repair and calibration that includes that sensors was successful

Similarly, other testing or calibration data may be used to facilitate the verification process. For example, repair analytics component 112 may use vehicle sensor information obtained by identification component 108, as described earlier, to determine the success of a particular repair procedure step. The vehicle sensor information may include information gathered prior to the damage incident, after the damage incident, and after the completion of a repair step.

In some embodiments, repair analytics component 112 may obtain one or more stored repair standards (e.g., safety standards or manufacturer standards) for a particular type of identified vehicle and may use the repair standards to analyze and confirm that one or more of the repair procedures were completed in accordance with the on one or more standards.

As alluded to above, a conventional repair process is largely dependent on the repair technician reading and/or consulting the correct repair procedures. Because no verification process ensuring that the technician actually used all the relevant repair procedures exists, traditional repair shops risk failing to correctly repair the damaged vehicle. This is especially important when repairing structural defects. For example, unlike cosmetic defects, structural damage repaired without following the optimal order of repairs may result in the vehicle not being structurally sound and potentially causing injuries and even death to the occupants of the vehicle. Thus, verifying the accuracy of repair procedures improves the ability to control the quality of the repairs and ensures compliance with insurance carriers.

In some embodiments, repair analytics component 112 may be configured to provide real time or near real time feedback based on the analysis of captured repair completion information. For example, upon determining that a particular repair procedure step was not completed and/or not completed successfully, repair analytics component 112 may generate a message or a voice output indicating that user 150 must perform additional repair operations in order to complete the repair step successfully. In some embodiments, repair analytics component 112 may be configured to prevent user 150 from viewing a subsequent repair procedure step until a determination confirming that the current repair procedure step has been completed successfully (e.g., based on a stored standard or other similar threshold) is made.

In some embodiments, upon completing the repair process, repair analytics component 112 may be configured to obtain information related to repair procedure documents used by the repair technician during the repair process. For example, this information may be related to the repair procedures accessed and/or viewed, including information related the type of repair procedure files (e.g., image files or video files) viewed, particular parts of the repair instructions viewed (e.g., pages viewed, duration of viewing) or not viewed (e.g., parts skipped by user), number of times a particular file was accessed or viewed, and other such relevant information.

By virtue of obtaining repair completion information, including information related to how the repair procedure documents were viewed, as alluded to above, allows the system to furnish evidence that may be helpful in establishing future repair shop liability. That is, conventional repair shop can only demonstrate which repair procedure documents were printed but may not provide information which ones were actually viewed.

Furthermore, by determining viewing times of particular procedure and correlating with actual repair times, results in improved employee performance tracking and provides future training opportunities.

In some embodiments, repair analytics component 112 may be configured to generate a report based on the completion of each of the repair procedures steps. For example, the report may include repair completion information, including captured images, as well as information used to determine the satisfactory completion of each of the repair procedure steps. In some embodiments, repair analytics component 112 may be configured to effectuate presentation of the report in a GUI associated with repair procedure viewer 127 running on client computing device 104 so it can be accessed and viewed by user 150. In some embodiments, repair analytics component 112 may transmit the report to another party or system.

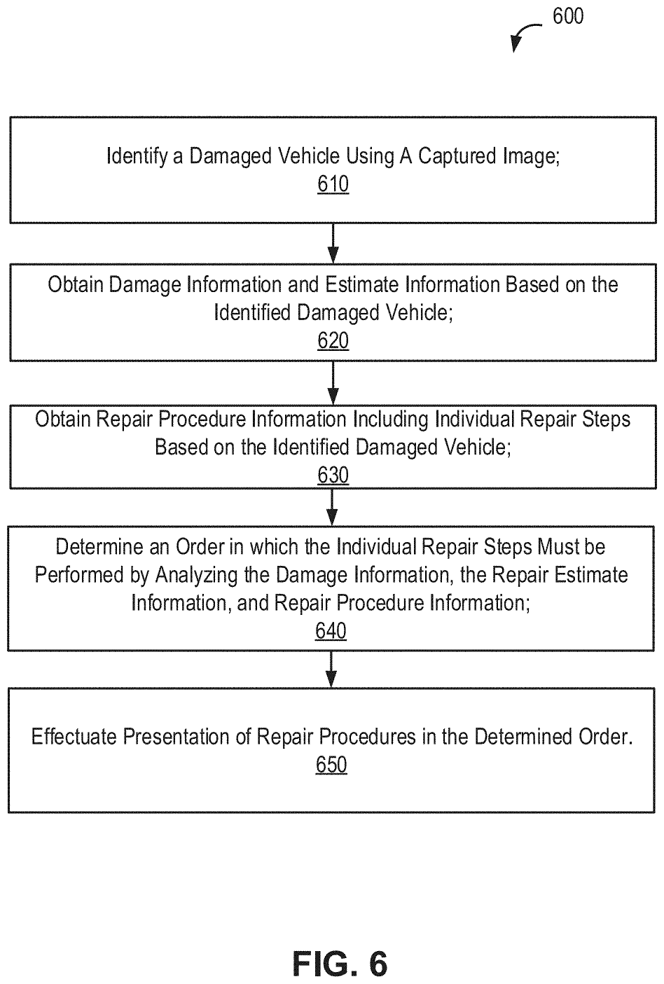

FIG. 6 illustrates a flow diagram depicting a method for generating repair procedures, which are displayed on a client computing device as a series of repair steps based on a determined order, in accordance with one embodiment. In some embodiments, method 600 can be implemented, for example, on a server system, e.g., repair management server 120, as illustrated in FIGS. 1-2. At operation 610, a user of a computer wearable device is directed to capture an image used to identify a damaged vehicle (e.g., VIN), for example by vehicle information component 106. Next, vehicle information is extracted from the captured image.

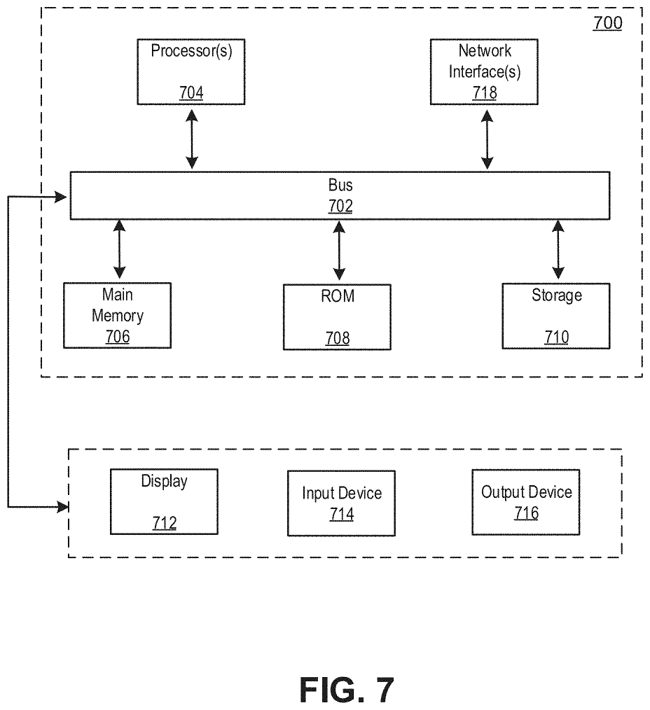

At operation 620, damage information and repair estimate information is obtained using the vehicle information, for example by repair procedures identification component 108. At operation 630, repair procedure information, including individual repair steps associated with each procedure, is obtained using the vehicle information. At operation 640, an optimized order in which the individual repair steps must be performed is determined by analyzing the damage information, the estimate information, and the repair procedure information. At operation 650, upon determining the order in which the individual repair steps must be performed, individual repair steps are displayed in a computing device, e.g., in a GUI associated with repair procedure viewer 127 running on computer wearable device 104.

Where circuits are implemented in whole or in part using software, in one embodiment, these software elements can be implemented to operate with a computing or processing system capable of carrying out the functionality described with respect thereto. One such example computing system is shown in FIG. 7. Various embodiments are described in terms of this example-computing system 700. After reading this description, it will become apparent to a person skilled in the relevant art how to implement the technology using other computing systems or architectures.

FIG. 7 depicts a block diagram of an example computer system 700 in which various of the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a transparent heads-up display (HUD) or an optical head-mounted display (OHMD), for displaying information to a computer user. An input device 714, including a microphone, is coupled to bus 702 for communicating information and command selections to processor 704. An output device 716, including a speaker, is coupled to bus 702 for communicating instructions and messages to processor 704.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 705. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 705. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method comprising:
obtaining repair estimate information associated with a damaged vehicle damaged during an adverse incident based on vehicle identification information captured by a computing device operated by a user, the repair estimate information comprising damage information specifying one or more damaged parts of the damaged vehicle, and repair estimate procedures for repairing the one or more damaged parts of the damaged vehicle;
obtaining vehicle repair workflow information based on the damage information associated with the repair estimate information, wherein the vehicle repair workflow information comprises repair workflow procedures for repairing the one or more damaged parts of the damaged vehicle;
obtaining historic repair information specifying repair procedures previously used to repair vehicle damage corresponding to the one or more damaged parts of the damaged vehicle;
determining one or more sets of repair procedures by correlating the repair estimate procedures with the repair workflow procedures, wherein each set of repair procedures comprises individual repair steps;
determining an order for performing the individual repair steps associated with each set of repair procedures by using a machine learning algorithm trained on the historic repair information; and
effectuating presentation of the one or more sets of repair procedures based on the order of the individual repair steps on the computing device.

2. The method of claim 1, further comprising obtaining vehicle status information comprising at least one of diagnostic information, sensor information, sensor calibration information, frame measurement information, and damage severity information for the damaged vehicle based on the vehicle identification information.

3. The method of claim 2, wherein determining the order for performing the individual repair steps associated with each set of repair procedures is based on the vehicle status information collected after the adverse incident.

4. (canceled)

5. (canceled)

6. The method of claim 1 further comprising:
generating instructions for capturing the vehicle identification information associated with the damaged vehicle using an image capture device of the computing device operated by the user; and
effectuating presentation of the instructions on the computing device directing the user to capture an image of the vehicle identification information.

7. The method of claim 6, further comprising:
extracting Vehicle Identification Number (VIN) from the captured image of the vehicle identification information; and
identifying the damaged vehicle based on the extracted VIN, wherein the identifying the damaged vehicle comprises identifying a make, a model, a sub-model, a trim level, and a year of manufacture of the damaged vehicle.

8. The method of claim 6, further comprising:
extracting vehicle license plate from the captured image of the vehicle identification information.

9. The method of claim 1, wherein the computing device comprises a computer wearable device worn by the user configured to facilitate hands-free repair of the damaged vehicle.

10. The method of claim 1, wherein determining the one or more sets of repair procedures comprises obtaining an image of one or more panels associated with the vehicle damage.

11. The method of claim 1, further comprising obtaining at least one of textual information, image information, and video information associated with individual repair steps of the one or more sets of repair procedures;
wherein effectuating presentation of the one or more sets of repair procedures comprises displaying the textual information, the image information, and the video information on a display of the computing device.

12. The method of claim 2, further comprising:
determining a success of completion of each repair step associated with the one or more sets of repair procedures by analyzing the vehicle status information obtained in accordance with the determined order of each individual repair step;
wherein the vehicle status information is collected after the repair step is completed.

13. The method of claim 1, further comprising receiving user input indicating completion of individual repair steps associated with the one or more sets of repair procedures.

14. A system for providing repairing procedures for hands-free vehicle repair, the system comprising
one or more physical processors configured by machine-readable instructions to:
obtain repair estimate information associated with a damaged vehicle damaged during an adverse incident based on vehicle identification information captured by a computing device operated by a user, the repair estimate information comprising damage information specifying one or more damaged parts of the damaged vehicle, and repair estimate procedures for repairing the one or more damaged parts of the damaged vehicle;
obtain a vehicle repair workflow information based on the damage information associated with the repair estimate information, wherein the vehicle repair workflow information comprises repair workflow procedures for repairing the one or more damaged parts of the damaged vehicle;
determine one or more sets of repair procedures by correlating the repair estimate procedures with the repair workflow procedures, wherein each set of repair procedures comprises individual repair steps;
obtain historic repair information specifying repair procedures previously used to repair vehicle damage associated with the one or more damaged parts of the damaged vehicle;
determine an order for performing the individual repair steps associated with each set of repair procedures by using a machine learning algorithm trained on the historic repair information; and
effectuate presentation of the one or more sets of repair procedures based on the order of the individual repair steps on the computing device;
wherein the computing device comprises a computer wearable device worn by the user configured to facilitate the hands-free repair of the damaged vehicle.

15. The system of claim 14, wherein the one or more physical processors are further configured to obtain vehicle status information comprising at least one of diagnostic information, sensor information, sensor calibration information, frame measurement information, and damage severity information for the damaged vehicle based on the vehicle identification information.

16. The system of claim 15, wherein the order of one or more sets of repair procedures is determined based on the vehicle status information collected after the adverse incident.

17. The system of claim 15, wherein the one or more physical processors are further configured to:
determine a success of completion of each repair step associated with the one or more sets of repair procedures by analyzing the vehicle status information obtained in accordance with the determined order of each individual repair step;
wherein the vehicle status information is collected after the repair step is completed.

18. The system of claim 14, wherein the one or more physical processors are further configured to receive user input indicating completion of individual repair steps associated with the one or more sets of repair procedures.

19. The system of claim 14, wherein the one or more physical processors are further configured to:
obtain viewing information associated with viewing of the individual repair steps of the one or more sets of repair procedures, the viewing information specifying viewing duration associated with each repair step, date and time, and document locations viewed, wherein the viewing information is obtained after each repair step is completed;
determine the individual repair steps that were not viewed by the user based on the viewing information associated with each repair step and
generate a repair status report based on the comprising the vehicle identification information of the damaged vehicle, the damage information specifying one or more damaged parts, the individual repair steps of the one or more sets of repair procedures, the viewing information associated with each repair step, and user information related to the user operating the computing device during the repair;
wherein the repair status report identifies the repair steps that were determined as not viewed based on the viewing information.

20. A non-transitory machine readable medium having stored thereon instructions comprising executable code which when executed by one or more processors, causes the processors to:
obtain repair estimate information associated with a damaged vehicle damaged during an adverse incident based on vehicle identification information captured by a computing device operated by a user, the repair estimate information comprising damage information specifying one or more damaged parts of the damaged vehicle, and repair estimate procedures for repairing the one or more damaged parts of the damaged vehicle;
obtain a vehicle repair workflow information based on the damage information associated with the repair estimate information, wherein the vehicle repair workflow information comprises repair workflow procedures for repairing the one or more damaged parts of the damaged vehicle;
determine one or more sets of repair procedures by correlating the repair estimate procedures with the repair workflow procedures, wherein each set of repair procedures comprises individual repair steps;
obtain historic repair information specifying repair procedures previously used to repair vehicle damage associated with the one or more damaged parts of the damaged vehicle;
determine an order for performing the individual repair steps associated with each set of repair procedures by using a machine learning algorithm trained on the historic repair information; and
effectuate presentation of the one or more sets of repair procedures based on the order of the individual repair steps on the computing device;
wherein the computing device comprises a computer wearable device worn by the user configured to facilitate the hands-free repair of the damaged vehicle.

21. The medium of claim 19, wherein the executable code, when executed by the processors, further causes the processors to:
generate instructions for capturing the vehicle identification information associated with the damaged vehicle using an image capture device of the computing device operated by the user; and
effectuate presentation of the instructions on the computing device directing the user to capture an image of the vehicle identification information.

22. The medium of claim 19, wherein the executable code, when executed by the processors, further causes the processors to:
extract Vehicle Identification Number (VIN) from the captured image of the vehicle identification information; and
identify the damaged vehicle based on the extracted VIN, wherein the identifying the damaged vehicle comprise identifying a make, a model, a sub-model, a trim level, and, and a year of manufacture of the damaged vehicle.

23. The medium of claim 19, further comprising:
extracting vehicle license plate from the captured image of the vehicle identification information.

24. The medium of claim 19, wherein the executable code, when executed by the processors, further causes the processors to:
obtain at least one of textual information, image information, and video information associated with individual repair steps of the one or more sets of repair procedures;
wherein the presentation of one or more sets of repair procedures is effectuated by displaying the textual information, the image information, and the video information on a display of the computing device.
